(19) United States
(12) Patent Application Publication
(10) Pub. No.: US 2017/0260075 A1
(43) Pub. Date: Sep. 14, 2017

(54) PRE-TREATMENT OF SUPERSATURATED WARM WATER

(71) Applicant: SUEZ INTERNATIONAL, Paris La Defense Cedex (FR)

(72) Inventor: Loic DANIEL, Rueil Malmaison (FR)

(73) Assignee: SUEZ INTERNATIONAL, Paris La Defense Cedex (FR)

(21) Appl. No.: 15/508,753

(22) PCT Filed: Sep. 3, 2015
(86) PCT No.: PCT/IB2015/056700

§ 371 Date: Mar. 3, 2017

(30) Foreign Application Priority Data
Sep. 5, 2014 (FR) 14 58329

(51) Int. Cl. C02F 5/06; C02F 1/44

(52) U.S. Cl. CPC C02F 5/06; C02F 1/441; C02F 2103/06

(57) ABSTRACT

Method for desalination of water by reverse osmosis, including a first desaturation step.

The present invention pertains to a method for desalination by reverse osmosis of hot water, comprising a chemical pretreatment of said water prior to the reverse osmosis treatment.

Reverse osmosis is one of the most widely used methods for preparing potable water from surface or subsurface water, especially from marine salt water.

Accordingly there are a number of plants in existence for treating such hot supersaturated water with reverse osmosis, particularly in Saudi Arabia. All of these plants have until now been designed according to the succession of steps below:
1. groundwater pumping,
2. cooling-tower cooling to lower the temperature of the water to a level which the reverse osmosis membranes can accept,
3. optionally a complementary step combining decarbonatation and/or softening and/or desilication and/or iron removal, to enhance the reverse osmosis yield,
4. subsequently a one- or two-stage filtration step, to retain the finer particles which would risk clogging the reverse osmosis membranes,
5. injection of a chemical reagent called a sequestrant, to enhance the reverse osmosis yield,
6. a cartridge filter step with a nominal cutoff of 5 to 10 micrometres (though possibly above or below this range, depending on the design choices). This step acts to protect against accidental arrival of suspended matter,
7. lastly the reverse osmosis step, desalinating the water to the level required for its intended use.

It is of course possible to use heat exchangers without loss of CO₂, but such apparatus is found to be much more expensive than open cooling towers (which take off some of the water for treatment, to produce the desired cooling) and therefore become economically unviable when the flow for treatment is greater than a few m³/h.

In order to limit or prevent precipitation of carbonate, an operation sometimes carried out is the injection of an acid and/or a sequestrant upstream of the cooling towers, the same sequestrant and acids sometimes, as a complement, also being injected upstream of the filtration. In both cases, the objective of adding such reagents is to lower the precipitation potential in the course of traversal of the cooling towers and the filters, and so to protect these items of equipment against the harmful accumulation of material.

These solutions, however, have great drawbacks, associated with the precipitation of certain ions which are present in this hot water.

The reason is that this water for desalination is of subsurface origin, originating in particular from aquifers contained in groundwater compartments.

Like all natural waters, this water therefore conforms to the so-called calco-carbonic balance which governs the equilibria between Ca²⁺, HCO₃⁻, CO₃²⁻, H⁺ and OH⁻ ions and also the species CO₂ and CaCO₃, in accordance with known equilibrium laws each governed by a constant; they may be represented by the simplified equations below:

CO₂+OH⁻<=>HCO₃⁻ [1]

HCO₃⁻<=>H++CO₃²⁻ [2]

Ca²⁺+CO₃²⁻<=>CaCO₃ [3]

Consequently, during traversal of the cooling tower, the loss of CO₂ causes a rise in pH, which then exceeds the equilibrium pH. In order to restore equilibrium under these new conditions, the water will tend to produce carbonate ions CO₃²⁻ from the bicarbonate ions HCO₃⁻ as per [2]. This additional carbonate, however, then gives rise to a shift in the equilibrium [3] towards the appearance of calcium carbonate CaCO₃, which is insoluble and therefore undergoes precipitation.

Furthermore, the addition of oxygen to this water, which is lacking in oxygen, gives rise to the oxidation and rapid precipitation of the iron, generally present in a variable amount, possibly up to several mg/l of iron. If the iron were to precipitate on its own, it would to a large extent be washed out by the water in the tower; however, when the calcium carbonate precipitates, the iron precipitate tends to join with it, thereby further increasing the clogging load in the cooling tower.

The precipitation and accumulation of precipitates in the exchange structure of the cooling tower give rise to two major drawbacks:
1. the structure becomes heavier, this being the most serious consequence; the structure may even break if it is not cleaned on time. This periodic cleaning reduces the availability of the system.
2. a loss of cooling yield, which may necessitate a reduction in the plant throughput.

The precipitation and accumulation of precipitates in the filter lead to the following:
1. blocking of moving equipment items (valves, pumps),
2. solidification of the filtering material, thereby compromising its filtration activity and its daily automated washing, and
3. accumulation of clogging matter, thereby reducing the cycle duration and degrading the quality of the water directed to the reverse osmosis unit.

Acidification upstream of the tower is sometimes used in order to reduce the bicarbonate initially present and therefore the potential for formation of carbonate. However, with water typically containing 3 milliequivalents of bicarbonate, this represents possible hydrochloric acid consumption of up to 110 mg/l of HCl, or almost 300 mg/l of commercial 38% strength acid, and this represents a significant operating cost and also storage difficulties. Furthermore, the conversion (recovery) of the downstream reverse osmosis system does not benefit very greatly from this removal, since the level of calcium is not lessened and the risk of precipitation by calcium sulfate therefore remains the limiting factor for the reverse osmosis recovery.

Sometimes a sequestrant product is also used, and will limit or delay precipitation in the cooling tower. This product, though, is quite expensive, its application at this site is still empirical, and it may have detrimental side effects in terms of the filtration, by degrading the efficiency with which suspended matter is removed from the filter. It is also possible for the sequestrant product to lose its efficacy on contact with the exchange mass in the cooling tower or with the filtration mass in the filter, and this may cause subsequent precipitation that are harmful to these systems.

Therefore, major drawbacks of the methods hitherto employed are:
1. a substantial risk of precipitation of calcium carbonate and iron in the cooling tower and in the subsequent filtration step,
2. a loss of cooling yield of the tower owing to the accumulated precipitates,
3. a sharp rise in the maintenance frequency for the cooling tower, giving rise to accelerated tower wear and loss of availability,
4. a risk of mechanical damages to the cooling tower if maintenance is not carried out in time,
5. a loss of performance of the filtration step owing to the precipitates accumulated over a cycle,
6. a risk of solidification of the filtering medium, of blockage of the valves of the filter, and of clogging and inactivation of the filter sensors,
7. increased risks of contamination of the reverse osmosis membrane, and
8. a high cost owing to the reagents used to limit or eliminate precipitation.

There is therefore a need for a method which is able to reduce or even prevent the precipitation and the accumulation of precipitates in the exchange structure of the cooling tower and in the filter.

The inventors have now discovered that by inserting a desaturation step before any cooling, it is possible to reduce or even eliminate the precipitation problems.

Accordingly, the object of the present invention is a method for desalination of water by reverse osmosis, comprising a desaturation step prior to the steps of cooling and of reverse osmosis treatment.

For the purposes of the present invention, “water for desalination” refers to water of subsurface origin, coming in particular from aquifers contained in groundwater compartments, and having as principal characteristics:
a temperature of greater than 40° C., preferably of between 40° C. and 80° C.,
a brackish nature, meaning that the sum of ions selected from the list calcium, magnesium, sodium, potassium, carbonates, bicarbonates, chlorides, sulfates or a mixture thereof is greater than 500 mg/l, and
a high CO₂ content, giving it an equilibrium pH of less than 7.5 and preferably less than 7.

This water may optionally further comprise the compounds selected from the list:
an iron content greater than 50 μg/l,
a manganese content greater than 25 μg/l,
a silica content greater than 10 mg/l,
sulfur in colloidal form or in the form of hydrogen sulfide, in an amount greater than 10 μg/l,
one or more radionuclides, such as radium or uranium, such that the overall alpha activity is greater than 0.5 Bq/l, or
a mixture of thereof,
   at high levels.

By way of example, a brackish water for desalination may have the following characteristics:

| Temperature = | 60° | C. |
|---|---|---|
| Calcium = | 360 | mg/l |
| CO₂ = | 60 | mg/l |
| pH = | 6.7 | |
| HCO₃ = | 190 | mg/l |
| Iron = | 3 | mg/l |
| Manganese = | 200 | μg/l |
| Silica = | 15 | mg/l |
| Overall alpha | ≧0.5 | Bq/l |
| activity | | |

In accordance with the invention, this step may be carried out immediately prior to filtration or may be separated from the filtration step by other steps, such as a cooling step, for example.

This desaturation step can easily proceed with waters having a temperature greater than 40-45° C., this having a further advantage, moreover, since at a higher temperature, the rates of the relevant chemical reactions accelerate, thereby enhancing the precipitation yield in the dedicated unit, and the solubility of the calcium carbonate decreases, thereby making it easier for this salt to be removed down to low levels, if desired.

In one advantageous embodiment of the invention, said desaturation step is alternatively a decarbonatation step or a softening step or a combination of these two steps.

Decarbonatation involves reducing the level of bicarbonate. Softening involves reducing the level of dissolved calcium. On an industrial basis, decarbonatation and softening are achieved using lime, the latter being a relatively inexpensive reagent. Sodium hydroxide is also sometimes used for this purpose.

The reactions are as follows:

With lime: Ca²⁺+Ca(OH)₂+2HCO₃⁻->2CaCO₃+2H₂O

With sodium hydroxide: Ca²⁺+NaOH+HCO₃⁻->CaCO₃+Na⁺+H₂O

Simple decarbonatation+softening with lime (or with sodium hydroxide) is sufficient on its own to achieve the objective of non-precipitation in the upstream units, cooling tower and filtration step; however, these steps may be complemented by softening with calcium carbonate, in order to benefit from the presence of this clarification step and so to increase the recovery of the reverse osmosis.

Softening on its own involves exchanging the calcium present in the water for treatment with another highly soluble ion which therefore presents no risk of precipitation. The most commonly used reagent is sodium carbonate:

Ca²⁺+Na₂CO₃—>CaCO₃+2Na⁺

The decarbonatation reaction may be complete (removal of all the bicarbonate) or partial (diminishment of a fraction of the bicarbonate). The same thing applies in respect of the softening with the removal of the calcium. These choices will depend on the quality of the raw water and the treatment objectives.

A person skilled in the art, in the light of his or her general knowledge, will know how to select between decarbonatation and/or softening in dependence on the quality of the water for treatment and the outgoing quality objectives of the steps of aeration and recovery in the reverse osmosis. In general, decarbonatation and softening will be practised simultaneously, with lime or with sodium hydroxide, both operations pursuing the same objective of reducing the risk of precipitation of the calcium carbonate.

In one advantageous embodiment of the invention, the decarbonatation step is carried out either with lime or with sodium hydroxide, and the softening step is carried out alternatively with lime or with sodium hydroxide or with sodium carbonate.

In another advantageous embodiment of the invention, a desilication step is carried out simultaneously with said desaturation step, if silica is a limiting product for the subsequent reverse osmosis step.

In accordance with the invention, the desaturation step may be applied to water with a temperature of greater than 40° C. Where the temperature of the water is greater than 40° C., the desaturation step is followed by a step in which the water for desalination is cooled to a temperature of 40-45° C.

In accordance with the invention, the reactions described above may take place in a modified conventional reactor, as for example a sludge blanket reactor or sludge recirculation reactor; they may also be integrated into any other existing method that allows contact to be made with a material which will promote precipitation.

In one particularly advantageous embodiment of the invention, the method comprises, in this order, the following steps:

a. a desaturation step,

b. optionally and simultaneously with step a) a desilication step, then

c. optionally a step of cooling the water to 40-45° C. and subsequently

d. a filtration step (removal of suspended matter) and subsequently

e. a step of desalination by reverse osmosis.

In another embodiment, the cooling tower is positioned upstream of the reverse osmosis membrane, thereby reducing the operating costs associated with fouling of the cooling tower, and reducing capital costs, moreover, thanks to the positioning of the tower on the permeate line, the flow rate of which is lower than the feed flow rate.

Advantageously, if the water for desalination comprises radium, this embodiment allows the retention of radionuclides, especially radium or uranium, on the reverse osmosis membrane.

This cooling of the permeate of the osmoser prevents contamination of the ambient air with radon, which is a highly volatile element obtained from the disintegration of radium 226.

Apart from these economical advantages, an arrangement of this kind has the advantage of removing the risk of contamination of the atmosphere with radon, since the element radium will be retained by the reverse osmosis membranes before passage of the permeate into the cooling tower.

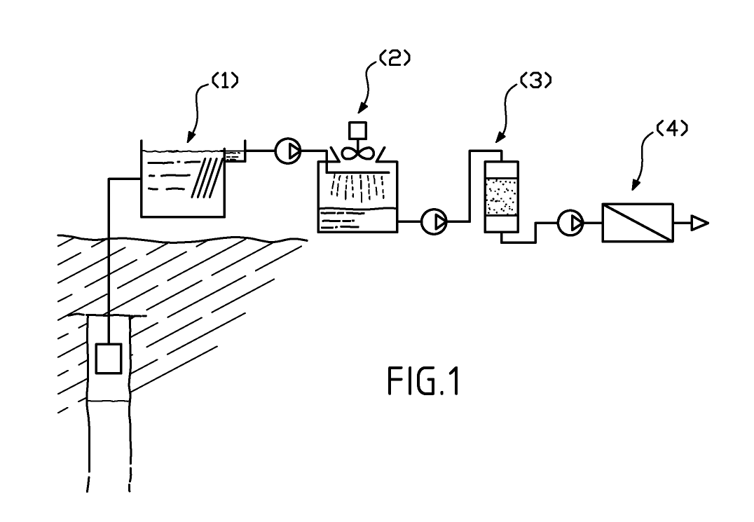

For further illustration of the method of the present invention, a description of it is given below:
as one embodiment. In the course of this description, reference is made to FIG. 1 of the attached drawings, which is a scheme illustrating the various steps of the method according to the invention; and
as an exemplary embodiment.

It is of course the case that these examples are not at all limiting in their nature.

Mode of Implementation According to FIG. 1

The raw water is fed to a tank (1), where it is subjected to desaturation and then taken to a cooling tower (2), before being subjected to filtration (3), and then to desalination by a reverse osmosis system (4).

### EXEMPLARY EMBODIMENT

A well water has the following characteristics:
pH 6.7
bicarbonate 190 mg/l HCO₃⁻
calcium 130 mg/l Ca²⁺
CO₂ 60 mg/l
temperature 60° C.

Direct passage of the raw water in the cooling tower could result in a loss of up to 60 mg/l of CO₂ during traversal of the tower. Assuming a loss of only 55 mg/l of CO₂, the precipitation potential of the CaCO₃ is approximately 24 mg/l, a part of which will accumulate in the structure of the cooling tower and in the filtration step.

The degree of conversion in the reverse osmosis step will be limited to 75% (with use of a sequestrant).

On the other hand, if decarbonatation+partial softening with lime alone is carried out, upstream of the cooling tower, in accordance with the present invention, a dose of 214 mg/l of Ca(OH)₂ (lime) will cause the formation of 446 mg/l of CaCO₃ sludge, which will be removed in the form of a suspension in the water.

The amounts in the water on exit from the clarifying unit will in this case be as follows:
Calcium=75 mg/l in the form of Ca²⁺
Alkalinity of less than 0.6 meq/l (essentially in the form of HCO₃⁻)
pH between 8.5 and 9.0

The water thus treated no longer contains calcium carbonate capable of precipitating in the cooling tower or in the filtration.

The conversion capacity in the reverse osmosis will be increased to 90%, or even more, if there are no other limiting salts.

Accordingly, by implementing the desaturation step in accordance with the invention, decarbonatation is complete, but the softening is partial, since the level of calcium is greater than the level of bicarbonate (including the bicarbonate formed by the reaction of the lime with the CO₂).

If, hypothetically, the reverse case were to occur, with calcium<bicarbonate, it would be possible to achieve complete softening and partial decarbonatation. In that case, it would be desirable to add sodium carbonate in order to continue the softening reaction and to obtain a lower final level.

By limiting the dose of lime, it is of course possible to carry out reduced diminishment both of calcium and of bicarbonate.

It is also possible to substitute sodium hydroxide for the lime. This reagent is more expensive, but generates less calcium carbonate sludge for the same result.

If, hypothetically, desaturation is carried out solely by softening, this softening is performed with a carbonate, generally sodium carbonate.

It is still possible to carry out dosage with acid upstream or downstream of the cooling tower, in order to adjust the alkalinity or the pH. Here again, the choice will depend on the treatment objectives, and the skilled person will be able to use his or her general knowledge in order to define the optimum conditions.

The present invention finds its primary application in the treatment of deep natural water which is hot and exhibits a calcium carbonate supersaturation potential. This treatment may be applied for production:
of water intended for human consumption
of water intended for supplying industrial processes, such as washing water, water involved in the production of manufactured products, water intended for feeding boilers, etc.
of water intended for irrigation.

This invention may also be applied to the treatment of water resulting from an industrial manufacturing process which would bring a calcium carbonate supersaturation potential in a water of more than 40-45° C., if the aim is to recycle the water, recover components from it, or treat it prior to discharge.

1. Method for desalination of water by reverse osmosis, comprising a desaturation step prior to the reverse osmosis treatment step.

2. Method according to claim 1, wherein said desaturation step is alternatively a decarbonatation step, a softening step or a combination of these two steps.

3. Method according to claim 1, wherein the decarbonatation step is carried out either with lime or with sodium hydroxide.

4. Method according to claim 1, wherein the softening step is carried out alternatively with lime or with sodium hydroxide or with sodium carbonate.

5. Method according to claim 1, wherein a desilication step is carried out simultaneously with said desaturation step.

6. Method according to claim 1, wherein said desaturation step is followed by a step of cooling the water for desalination to a temperature of 40-45° C. when the temperature of said water is greater than 40° C.

7. Method according to claim 1, further comprising, in this order, the following steps:
a desaturation step,
a filtration step including removal of suspended matter, and subsequently
a step of desalination by reverse osmosis.

8. Method according to claim 1, wherein the water for desalination comprises compounds selected from calcium, magnesium, sodium, potassium, carbonates, bicarbonates, chlorides, sulfates or a mixture thereof.

9. Method according to claim 8, wherein the water for desalination comprises compounds selected from calcium, magnesium, sodium, potassium, carbonates, bicarbonates, chlorides, sulfates or a mixture thereof, with a total amount of at least 500 mg/l.

10. Method according to claim 1, wherein the water for desalination further comprises compounds selected from iron, manganese, silica, sulfur or a mixture thereof.

11. Method according to claim 2, wherein the permeate is cooled to a temperature at least less than 45° C.

12. Method according to claim 1, characterized in that the water for desalination comprises radionuclides.

13. Method according to claim 1, characterized in that the permeate of said water for desalination is cooled following its osmosis membrane traversal.

14. Method according to claim 2, wherein the decarbonatation step is carried out either with lime or with sodium hydroxide.

15. Method according to claim 2, wherein the softening step is carried out alternatively with lime or with sodium hydroxide or with sodium carbonate.

16. Method according to claim 3, wherein the softening step is carried out alternatively with lime or with sodium hydroxide or with sodium carbonate.

17. The method of claim 11, wherein the permeate is cooled to a temperature less than 40° C.

18. The method of claim 7, further comprising a desilication step performed simultaneously with the desaturation step.

19. The method of claim 7, further comprising a step of cooling the water to 40-45° C. between the desaturation and filtration steps.

20. The method of claim 18, further comprising a step of cooling the water to 40-45° C. between the desaturation and filtration steps.
